(19) United States
(12) Patent Application Publication
(10) Pub. No.: US 2010/0008614 A1
(43) Pub. Date: Jan. 14, 2010

(54) AXIAL ROLLER BEARING

(75) Inventors: James Kevin Brown, Rock Hill, SC (US); Scott Harris, The Woodlands, TX (US); Eric Clark, Rock Hill, SC (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/373,954

(22) PCT Filed: Jun. 14, 2007
(86) PCT No.: PCT/EP07/55880

§ 371 Date: Jan. 15, 2009

Related U.S. Application Data
(60) Provisional application No. 60/807,562, filed on Jul. 17, 2006.
(60) Provisional application No. 60/823,153, filed on Aug. 22, 2006.

(51) Int. Cl. F16C 23/10

(52) U.S. Cl. 384/563

(57) ABSTRACT

An axial rolling bearing (1) including a cage (6) which contains rolling bodies (7) and which is arranged between two running disks (2, 3) is provided, wherein the running disks (2, 3) have in each case one radial section (4, 5) which forms a raceway and in each case one axially aligned radially outer rim (8, 9) which adjoins the radial section (4, 5), which rim (8, 9) and radial section (4, 5) overlap in the axial direction. The radially outer running disk (3) has a larger diameter than the radially inner running disk (2), and at least the radially inner running disk (2) has a radially inner axially extending rim which adjoins the radial section (4) which forms the raceway. In order to be able to adjust the throughflow quantity of lubricant through the axial rolling bearing in a targeted fashion, it is provided that the radially inner rim (10) of the inner running disk (2) extends axially outward and is elongated so as to form a flange (11). The cage (6) has a radially outer section (12) which is supported against the radially outer rim (8) of the radially inner running disk (2), and the cage (6) has a radially inner section (13) which is angled so as to form an axially outwardly aligned rim (14). The flange (11) of the radially inner running disk (2) and the rim (14) of the cage (6) are formed to have the same axial direction in order to form a labyrinth seal.

### BACKGROUND

The invention relates to an axial rolling bearing comprised of a cage that contains rolling bodies and that is arranged between two running disks, wherein the running disks each have a radial section forming a raceway and an axially oriented, radially outer rim that is adjacent to the radial section, wherein these rims overlap in the axial direction, wherein the radially outer running disk has a larger diameter than the radially inner running disk and for which at least the radially inner running disk has a radially inner, axially extending rim that is adjacent to the radial section forming the raceway.

DE 102 58 823 A1 describes an axial rolling bearing that should be suitable for transmission gears of automobiles whose running disks are provided with outer, axially angled rims that are directed against each other and that each have openings that should simplify the flow of lubricant through axial rolling bearing. The flow of lubricant through the axial rolling bearing should be simplified there through particularly large openings, because in DE 102 58 823 A1 it is specified as a disadvantage of the state of the art that previously known technical solutions for the lubricant would exhibit too high a flow resistance that could lead to separation of the lubricant film.

An axial rolling bearing according to the class is known from U.S. Pat. No. 4,659,050 with reference to FIG. 12 in this document. For this axial rolling bearing whose named advantages include low production costs, balls are used as rolling bodies, so that this axial rolling bearing cannot be used for all fields of application.

From DE 196 18 216 B4, an axial rolling bearing with a cage and rolling bodies contained in cage pockets is provided, wherein the cage is arranged between two plan-parallel running disks formed, in particular, from sheet metal. These three components are assembled into one structural unit by mutual, positive-fit engagement. Here, at least the first running disk transitions at a peripheral edge into an axially directed collar surrounding the cage with play, so that at least an annular gap is created. The cage has a sigma-shape in longitudinal section and is provided with passage openings spaced apart radially from the pockets in the region of the annular gap. With this construction, the flow resistance for the lubricant should also be reduced, wherein, as a reason for the flow resistance, the tight radial and axial gaps between the running disks and the cage, as well as the tight clearances between the rolling bodies and the pockets of the cage are specified.

Another technical solution that is to allow the most unimpaired and directed flow possible of lubricant through the axial rolling bearing is described in DE 103 13 183 A1. There, a radially outer rim of the radially outer running disk is lengthened into an axial flange. The flange adjacent to the rim acts as a guide plate for the lubricant flow and provides for its directed outlet from the bearing.

As far as the described constructions relate to the use of axial rolling bearings in gears of automobiles, up until now the most open structures possible have been preferred through which lubricant that is required for lubricating the axial rolling bearing and for lubricating other components of the gear can flow with as little resistance as possible. Such flow-open structures, however, have not only advantages. The flow-open structures also lead, namely, to a relatively high consumption of lubricant that is circulated by hydraulic pumps in the transmission or is pumped into the transmission. The lower the flow resistance exhibited by the axial rolling bearing, the higher the quantity of circulated lubricant must be. This makes a pump with relatively high output necessary. Furthermore, it could be determined that conventional axial rolling bearings themselves act as pumps starting at a certain rotational speed, whereby the quantity of circulating lubricant is increased further. Up until now, the flow rate was considered a resultant but not as a determinant.

For this reason, a reduced flow rate of lubricant would lead to a higher efficiency of the entire transmission structure.

### SUMMARY

The invention is based on the objective of creating an axial rolling bearing that overcomes the mentioned disadvantages. In particular, the bearing should exhibit a definable lubricant flow that corresponds, for example, only to that lubricant quantity that the bearing itself requires for disruption-free operation. In another setting, another lubricant flow through the axial bearing should be realizable.

The invention is based on the knowledge that the stated problem can be solved in a surprisingly simple way in that the radial and axial geometries of the running disks and the cage are adapted to each other such that a labyrinth seal is imitated that forms a choke for the lubricant flow.

According to the features of the main claim, the invention starts from an axial rolling bearing comprised of a cage that contains rolling bodies and that are arranged between two running disks, wherein the running disks each have a radial section forming a raceway and an axially oriented, radially outer rim that is adjacent to the radial section, wherein these rims overlap in the axial direction, wherein the radially outer running disk has a greater diameter than the radially inner running disk and in which at least the radially inner running disk has a radially inner, axially extending rim that is adjacent to the radial section forming the raceway.

In addition it is provided that the radially inner rim of the inner running disk is directed axially outward and is lengthened into a flange, the cage has a radially outer section that is supported against the radially outer rim of the radially inner running disk, and that the cage has a radially inner section that is constructed into an angled rim directed axially outward, wherein the flange of the radially inner running disk and the rim of the cage for forming a labyrinth seal are constructed pointing in the same axial direction.

Through this construction it is advantageously achieved that as much axial overlap as possible is formed, which makes an essentially unimpaired flow through the axial rolling bearing impossible. The lubricant flow is deflected as often as it flows, so that it can pass through the axial rolling bearing only via a relatively long path. Nevertheless, the basic supply of lubricant to the axial rolling bearing is maintained.

Therefore, because the radial inner rim of the inner running disk is directed axially outward and is lengthened into a flange, an especially effective reduction of the lubricant flow rate is achieved. This flange is used somewhat as a guide plate by means of which a certain flow direction is given to the lubricant. In addition, this ring flange can be used to connect the axial rolling bearing in a very simple way to a housing part, for example, a conversion gear.

In studies with an axial bearing according to the invention, it has been discovered surprisingly that the lubricant flow rate can be influenced in a desired way by the axial rolling bearing, indeed, both for a certain volume flow per minute at a given pressure and also vice versa.

In addition it can be provided that an axially outer section of the radially outer running disk is angled axially inward for forming a rim, wherein this rim is spaced at least radially from the radially inner rim of the inner running disk and covers the axially outward directed rim of the cage, wherein a gap remains between the rims.

In other practical improvements it can be provided that the rim of the radially outer running disk formed as a flange covers the flange of the radially inner running disk at least partially in the axial and radial directions, wherein a gap is formed between the flanges.

Another construction of the invention provides that the flange of the radially inner running disk is angled at its axial end radially inward into an border, wherein an edge of this border and a radial bottom side of the flange of the radially outer running disk are at approximately the same radial height, wherein a gap is constructed between the edge of the radially inner running disk and the flange of the radially outer running disk.

It also lies within the scope of the invention that the rim of the radially lower section of the cage is provided with a double, axial-radial bend that is comprised of a radially inward pointing section and an axial flange, wherein this flange at least partially covers the flange of the radially inner running disk radially and axially.

This construction can be expanded such that the axial distance between the flange of the radially inner running disk and the flange of the cage is equal to zero.

In one especially practical improvement of the invention, it is provided that the axially outer section of the radially outer running disk has an axially inward directed bend in the form of a rim whose lower edge is arranged at the same radial height as a lower edge of the flange of the cage.

Also advantageous is a construction of the invention that is distinguished in that a gap is formed between the radially inward pointing section of the rim of the cage and an end edge of the rim of the radially outer running disk.

It also lies in the scope of the invention to provide that at least one opening or borehole is formed in the axially outer section of the radially outer running disk.

This construction can also be expanded such that the axially inward directed rim of the radially outer running disk has at least one radially extending borehole, wherein it can be expanded such that the borehole of the axially inward directed rim of the radially outer running disk has a smaller diameter than the borehole in the axially outer section of this running disk.

Other practical constructions of the invention are distinguished in that the radially outer and axially oriented rim of the radially outer running disc has, in the radially outer direction, a tab-shaped projection that is made from several holding tabs spaced apart from each other uniformly in the peripheral direction or as a radial border extending 360°.

It also lies in the scope of the invention that the rolling bodies are formed as needles or rollers. Also practical is an improvement of the invention in which it is provided that the cage has pockets with a number N, wherein the number of rolling bodies inserted into the pockets corresponds to the number N.

Finally, especially advantageous is a construction of the invention that is distinguished in that the cage has pockets with a number N, wherein the number of rolling bodies inserted into the pockets equals N−n, wherein n≧1.

### BRIEF DESCRIPTION OF THE DRAWINGS

The invention will be explained in greater detail below with reference to the accompanying drawing. Shown therein are:

FIG. 1 is a cross-sectional view through a first axial rolling bearing according to the invention,

FIG. 2 is a cross-sectional view through a second axial rolling bearing according to the invention,

FIG. 3 is a cross-sectional view through a third axial rolling bearing according to the invention,

FIG. 4 is a cross-sectional view through a fourth axial rolling bearing according to the invention,

FIG. 5 is a cross-sectional view through a fifth axial rolling bearing according to the invention,

FIG. 6 is a cross-sectional view through a sixth axial rolling bearing according to the invention,

FIG. 7 is a cross-sectional view through a seventh axial rolling bearing according to the invention, and

FIGS. 8a, 8b are tables of flow rates.

### DETAILED DESCRIPTION OF PREFERRED EMBODIMENTS

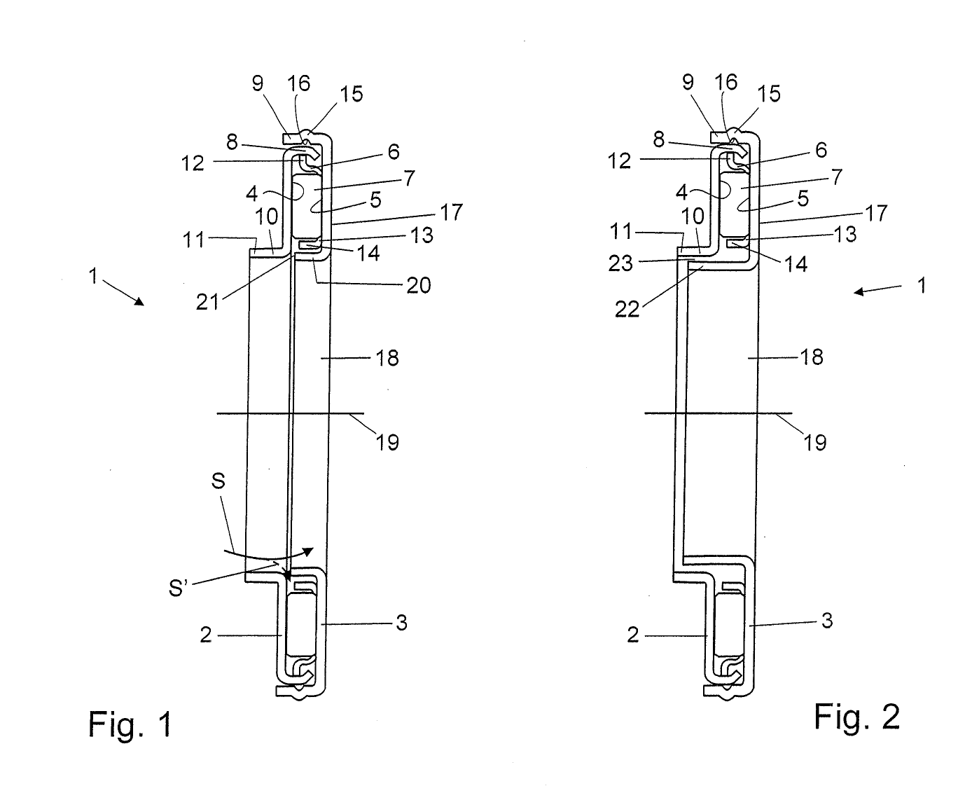

In each of FIGS. 1 to 5, a different embodiment of an axial rolling bearing 1 according to the invention is shown that has, in all of the variants, two running disks 2 and 3 that each have a radial section 4 and 5, respectively, used as raceways of rolling bodies 7 guided in a cage 6.

On the outer peripheral edge, axially oriented rims 8 and 9 that are set against each other extend adjacent to the radial sections 4 and 5, respectively, wherein the rim 9 of one running disk 3 overlaps the rim 8 of the other running disk 2. Therefore, the radially inner running disk 2 has a smaller diameter than the radially outer running disk 3, overlapping it.

On the inner peripheral edge of the radial section 4 of the radially inner running disk 2, a radially inner and axially running rim 10 that is directed axially outward and that is lengthened into a flange 11 is adjacent. The rim 10 with the flange 11 is directed opposite the named rim 8, so that the radially inner running disk 2 has an approximately S-shaped cross section.

The cage 6 has a radially outer section 12 that is supported against the radially outer rim 8 of the radially inner running disk 2. The cage 6 further has a radially inner section 13 that is constructed into an angled, axially outwardly directed rim 14.

The rim 9 of the radially outer running disk 3 has, in the radially outward direction, a tab-shaped projection 15 that is either made from several holding tabs spaced apart from each other uniformly in the peripheral direction or is constructed as an edge extending 360°. The projection 15 is used for simplifying the joining of the two running disks 2, 3 and can also be used as a snap tab by which the axial rolling bearing 1 can be locked into a corresponding housing recess of a transmission.

In addition, a recess 16 formed in the production of the projection 15 forms another component of the labyrinth seal formed by the individual components of the axial rolling bearing. Its components include, in particular, the radially outer rims 8 and 9 directed opposite each other of the two running disks 2 and 3, the radially inner rim 10 with flange 11 of the radially inner running disk 2, the cage 6 with its upper section 12 directed against the rim 8 and with its radially lower section 13 angled to form the rim 14, wherein this rim 14 and the flange 11 have the same orientation.

All of the embodiments have in common that an axially outer section 17 of the radially outer running disk 3 opens into a central bearing opening 18 with bearing axis 19.

In FIG. 1, a first embodiment is shown in which the mentioned components of the labyrinth seal are expanded by another component. In this embodiment, the axially outer section 17 of the radially outer running disk 3 is angled axially inward for forming a rim 20. This rim 20 is spaced apart axially and radially from the radially inner rim 10 of the smaller running disk 2 and completely covers the rim 14 of the cage 6 axially and radially. Between the rim 20 and the rim 10 there remains only a small, primarily radial gap 21 in which the lubricant can flow into the axial bearing 1. The much larger portion of the quantity of lubricant, however, flows past the rims 10, 14, 20 acting as guide plates, which is indicated with the arrows S and S′.

In FIG. 2, a second embodiment of an axial rolling bearing 1 according to the invention is shown that essentially corresponds to the axial rolling bearing shown and described in FIG. 1. Deviating from the embodiment shown in FIG. 1 is the axially outer section 17 of the radially outer running disk 3 indeed also angled axially inward for forming a rim or flange 22. This flange 22, however, not only completely covers the rim 14 of the cage 6 axially, but also partially covers the flange 11 of the radially inner running disk 2. Between the mentioned flange 11 and 22, a narrow gap 23 for lubricant inflow remains that extends axially.

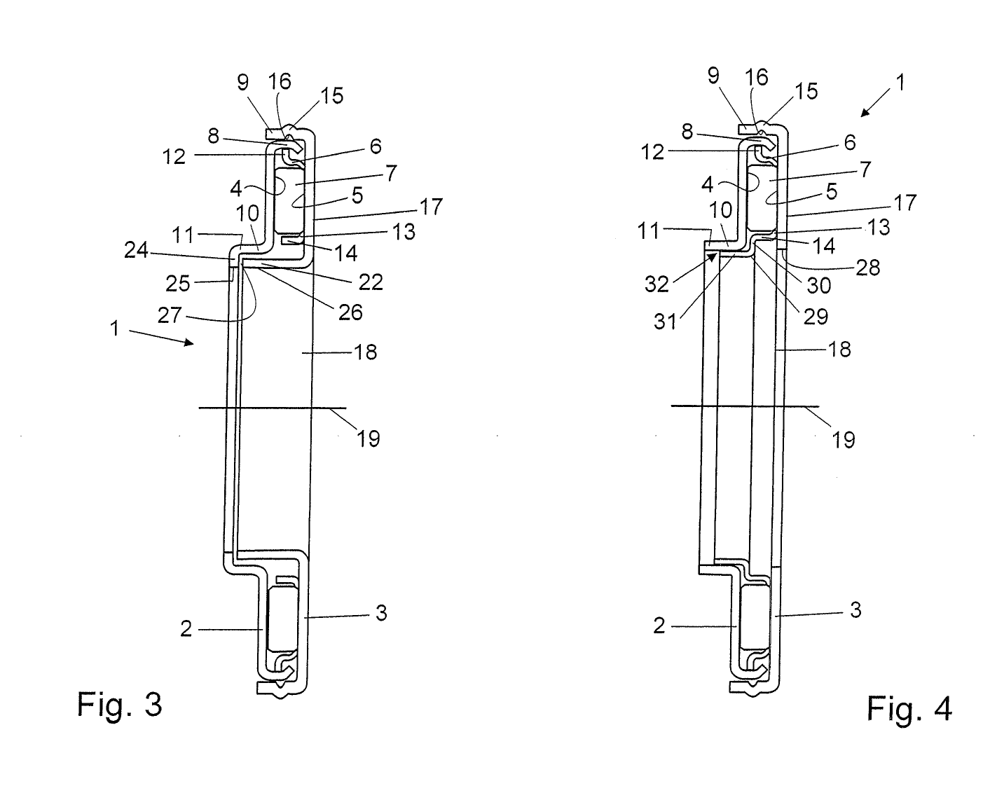

In FIG. 3, a third embodiment of an axial rolling bearing 1 according to the invention is shown that essentially corresponds to the axial rolling bearing shown and described in FIG. 2. Here, the axially outer section 17 of the radially outer running disk 3 is also angled axially inward for forming a rim or flange 22 and completely covers not only the rim 14 of the cage 6, but also partially the flange 11 of the radially inner running disk 2.

The flange 11 is also angled at its axial end radially inwardly into a border 24, wherein one edge 25 of the border 24 is at the same radial height with a radial lower side 26 of the flange 22. Between the border 24 and the flange 22, a radial gap 27 remains into which lubricant can flow. The far predominant part of the lubricant, however, passes the flange 11 with border 24 acting as a guide plate and flange 22.

In FIG. 4, a fourth embodiment of an axial rolling bearing 1 according to the invention is shown. This has a radially inner running disk 2 that corresponds to the running disk 2 shown in FIG. 1 and FIG. 2. In contrast to that of FIGS. 1 to 3, the radially outer running disk 3 has no radially inner rim or flange in extension of the axially outer section 17. In this embodiment, the axially outer section 17 ends with a radially inner, straight end edge 28. Nevertheless, in order to maintain the function of a labyrinth seal or guide plates for deflecting the lubricant flow, the cage 6 is more strongly integrated into the system, namely, such that the rim 14 of the radially lower section 13 of the cage 6 is provided with a double axial-radial bend 29 that is made from a radially inwardly pointing section 30 and from an axial flange 31.

The flange 31 of the cage 6 has only a slight radial distance to the flange 11 of the radially inner running disk 2. Between the flange 11 and flange 31, a gap 32 remains through which lubricant can flow into the axial bearing. However, it also lies in the scope of the invention to place the flange 11 and the flange 31 against each other without a gap. It is also possible to form the flange 31 lengthened axially so far that its end edge aligns with the end edge of the flange 11. The axial spacing between these two flanges 11 and 31 would then be zero.

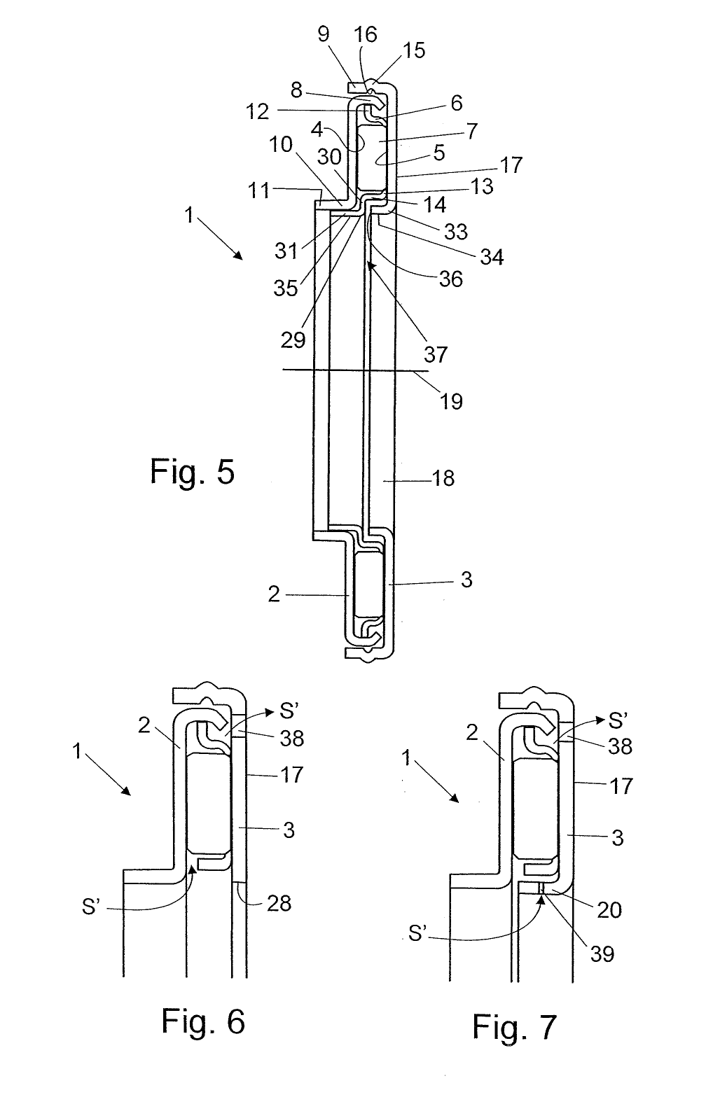

In FIG. 5, a fifth embodiment of an axial rolling bearing 1 according to the invention is shown whose radially inner running disk 2 and whose cage 6 with flange 31 correspond to the axial rolling bearing shown in FIG. 4. In contrast, the axially outer section 17 of the radially outer running disk 3 also has an axially inward directed bend in the form of a rim 33 whose lower edge 34 is arranged at the same radial height as a lower edge 35 of the flange 31 of the cage 6. Between the radially inward pointing section 30 of the rim 14 of the cage 6 and its end edge 36 of the rim 33, a gap 37 remains through which a small portion of the lubricant flow can flow into the axial rolling bearing 1. The largest part by far is deflected by the flange 11 of the smaller diameter bearing ring 2, by the rim 31 of the cage 6, and by the rim 33 of the larger diameter bearing ring 3, wherein these parts act as guide plates.

In FIG. 6, a partial view of a sixth embodiment of an axial rolling bearing 1 according to the invention is shown that corresponds with respect to the configuration of the radially inner running disk 2 and the cage 6 to the embodiments shown in FIGS. 1 and 2. In contrast, the radially outer running disk 3 has a configuration as was shown in FIG. 4 and described above.

Consequently, in this embodiment, the axially outer section 17 of the running disk 3 ends in the radially inner direction with a straight end edge 28. In addition, in the axially outer section 17 of the running disk 3, an opening or borehole 38 is formed. Here, a single borehole 38 or a plurality of boreholes 38 can be formed in the axially outer section 17 of the larger diameter running disk 3. This construction detail is used to achieve a higher flow rate of lubricant through the axial rolling bearing 1 relative to the previously described embodiments, which can be advantageous under certain requirements. The lubricant penetrating into the axial rolling bearing 1 and leaving this bearing through the borehole 38 is indicated by the arrows S′. The number and/or diameters of the boreholes 38 define, among other things, the lubricant flow that can be guided per unit time through the axial bearing. The one or more boreholes 38 also guide the lubricant flow in a desired way in a certain axial direction.

In FIG. 7, a partial view of a seventh embodiment of an axial rolling bearing 1 according to the invention is shown in which an opening or a borehole 38 is also formed in the axially outer section 17 of the larger diameter running disk 3. In the radially inner direction, the axially outer section 17 of the running disk 3 has an axially inwardly directed rim 20 according to the variant shown in FIG. 1. The rim 20 has a radially running borehole 39 that has a smaller diameter than the borehole 38 in the axially outer section 17 of the running disk 3. Through the borehole 39, lubricant can also penetrate into the axial rolling bearing 1 and can leave this bearing through the borehole 38, which is indicated by the arrows S′.

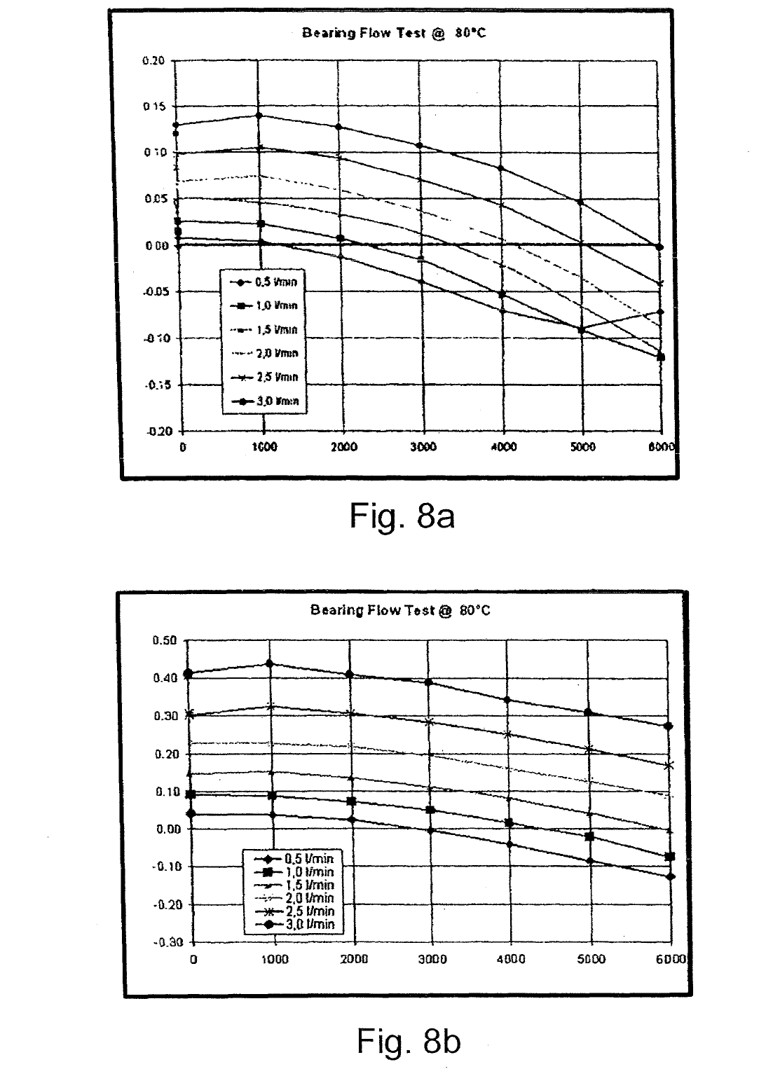

In FIGS. 8a and 8b, tabular measurement series are shown that each reproduce, on the vertical axis, the oil pressure measured in bar and, on the horizontal axis, a rotational speed in revolutions per minute. The measurements were performed at a temperature of 80° C. In FIG. 8a, values are specified that correspond to a lower flow rate of lubricant, while in the table according to FIG. 8b, values were obtained that represent a higher flow rate. These values were obtained in practical test series that were performed with differently constructed axial rolling bearings 1, wherein it was produced that according to the requirement profile, the axial rolling bearings can be easily adapted, namely such that various components or variants of the labyrinth seal of those described above were used or left out. For example, the values of a relatively high flow rate specified in FIG. 8a were given by measurement series that were performed with an axial rolling bearing according to FIG. 6, while the values of a relatively low flow rate shown in FIG. 8b were obtained with an axial rolling bearing 1 according to FIG. 1.

If the flow rate through the axial bearing 1 is to be increased, then it can also be provided that the number of rolling bodies 7 that are used is reduced. Here it is possible to not equip the pockets of the cage 6 in which rolling bodies 7 are inserted in the form of needles or rollers up to the maximum possible number. For example, 2, 4, 8, or 16 pockets of the cage 6 can remain empty and only the remaining pockets can be filled with rolling bodies 6.

### LIST OF REFERENCE SYMBOLS

1 Axial rolling bearing
2 Running disk
3 Running disk
4 Radial section
5 Radial section
6 Cage
7 Rolling body
8 Rim
9 Rim
10 Rim
11 Flange
12 Section
13 Section
14 Rim
15 Projection
16 Recess
17 Section
18 Bearing opening
19 Bearing axis
20 Rim
21 Gap
22 Flange
23 Gap
24 Border
25 Edge
26 Lower side
27 Gap
28 End edge
29 Bend
30 Section
31 Flange
32 Gap
33 Rim
34 Lower edge
35 Lower edge
36 End edge
37 Gap
38 Borehole
39 Borehole
S Arrow, flow direction
S′ Arrow, flow direction

1. Axial rolling bearing comprised of a cage that contains rolling bodies and that is arranged between two running disks, the running disks each have a radial section forming a raceway and an axially oriented, radially outer rim that is adjacent to the radial section, the rims overlap in an axial direction, a radially outer one of the running disks has a greater diameter than a radially inner one of the running disks and at least the radially inner running disk has a radially inner, axially extending rim that is adjacent to the radial section forming the raceway, the radially inner rim of the inner running disk is directed axially outward and extends into a flange, the cage has a radially outer section that is supported against the radially outer rim of the radially inner running disk, and the cage has a radially inner section that is constructed into an angled, axially outwardly directed rim, wherein the flange of the radially inner running disk and the rim of the cage are constructed pointing in the same axial direction to form a labyrinth seal.

2. Axial rolling bearing according to claim 1, wherein an axially outer section of the radially outer running disk is angled axially inward for forming a rim, wherein the rim of the radially outer running disk is spaced apart at least radially from the radially inner rim of the inner running disk and covers the axially outwardly directed rim of the cage, and a gap remains between the corresponding rims.

3. Axial rolling bearing according to claim 2, wherein the rim formed as a flange of the radially outer running disk covers the flange of the radially inner running disk at least partially in the axial and radial directions, and the gap is formed between the flanges.

4. Axial rolling bearing at least according to claim 2, wherein the flange of the radially inner running disk is angled on an axial end thereof radially inwardly to form a border, an edge of the border and a radial lower side of the rim formed as a flange of the radially outer running disk are at approximately a same radial height, and the gap is formed between the border of the radially inner running disk and the flange of the radially outer running disk.

5. Axial rolling bearing at least according to claim 1, wherein the rim of the radially lower section of the cage is provided with a double axial-radial bend that is made from a radially inward pointing section and from an axial flange, and the axial flange covers the flange of the radially inner running disk at least partially in the radial and axial directions.

6. Axial rolling bearing according to claim 5, wherein an axial distance between the flange of the radially inner running disk and the flange of the cage is equal to zero.

7. Axial rolling bearing according to claim 5, wherein an axially outer section of the radially outer running disk has an axially inward directed bend in the form of a rim having a lower edge that is arranged at a same height as a lower edge of the flange of the cage.

8. Axial rolling bearing according to claim 7, wherein a gap is formed between a radially inward pointing section of the rim of the cage and an end edge of the rim of the radially outer running disk.

9. Axial rolling bearing at least according to claim 2, wherein at least one opening or borehole is formed in the axially outer section of the radially outer running disk.

10. Axial rolling bearing at least according to claim 9, wherein the axially inwardly directed rim of the radially outer running disk has at least one radially extending borehole.

11. Axial rolling bearing according to claim 10, wherein the borehole of the axially inwardly directed rim of the radially outer running disk has a smaller diameter than the borehole in the axially outer section of the running disk.

12. Axial rolling bearing at least according to claim 1, wherein the axially oriented, radially outer rim of the radially outer running disk has in a radially outer direction a tab-shaped projection that is made from several holding tabs spaced apart from each other uniformly in a peripheral direction or is formed as a radial border extending 360°.

13. Axial rolling bearing according to claim 1, wherein the rolling bodies are needles or rollers.

14. Axial rolling bearing according to claim 1, wherein the cage has pockets with a number N, and a number of roller bodies inserted into the pockets corresponds to the number N.

15. Axial rolling bearing according to claim 14, wherein the cage has pockets with a number N, and the number of rolling bodies inserted into the pockets equals N−n, where n≧1.
